(19) United States
(12) Patent Application Publication
(10) Pub. No.: US 2012/0271445 A1
(43) Pub. Date: Oct. 25, 2012

(54) MULTIVARIABLE PREDICTIVE CONTROL OPTIMIZER FOR GLASS FIBER FORMING OPERATION

(75) Inventors: Wei Li, New Albany, OH (US); Michael D. Pietro, New Albany, OH (US)

(73) Assignee: OWENS CORNING INTELLECTUAL CAPITAL, LLC, Toledo, OH (US)

(21) Appl. No.: 13/288,302

(22) Filed: Nov. 3, 2011

Related U.S. Application Data
(63) Continuation-in-part of application No. 13/116,611, filed on May 26, 2011.
Application No. 13/116,611 is a continuation-in-part of application No. 13/089,457, filed on Apr. 19, 2011.

(51) Int. Cl. G05B 13/02; G05D 23/19

(52) U.S. Cl. 700/103

(57) ABSTRACT

A system and method for determining and controlling for cure status of binder on a fibrous product are disclosed. Cure status is monitored by measuring one or more control variables and attempting to keep them within known control limits. Exemplary control variables include oven temperatures at various locations and color values of sections of the fibrous product. Sensors such as thermocouples and image capture systems sense these variables continuously online and provide input signals for a MPC processor-optimizer. The MPC optimizers balances the constraints according to a programmed optimization function and priority ranking of control variables and solves for optimal control setting on manipulatable variables, such as oven fan speed, oven setpoint temperatures and coolant water flow rate.

### CROSS-REFERENCE TO RELATED APPLICATIONS

This application is a continuation-in-part of co-owned U.S. patent application Ser. No. 13/089,457 filed Apr. 19, 2011, and a continuation-in-part of co-owned U.S. patent application Ser. No. 13/116,611 filed May 26, 2011, both of which are incorporated in their entireties by reference.

### BACKGROUND OF THE INVENTION

This invention relates in general to a method and apparatus for making bindered insulation products from fibrous minerals like glass and, in particular, to quality control methods for determining the cure status, i.e. whether the binder is undercured, overcured or properly cured within specifications and process control limits, and optimizing the process if it is not within control limits.

Fibrous glass insulation products generally comprise randomly-oriented glass fibers bonded together by a cured thermosetting polymeric binder material. Molten streams of glass are drawn into fibers of random lengths and blown into a forming chamber or hood where they are randomly deposited as a pack onto a porous, moving conveyor or chain. The fibers, while in transit in the forming chamber and while still hot from the drawing operation, are sprayed with an aqueous dispersion or solution of binder. The residual heat from the glass fibers and combustion gases, along with air flow during the forming operation, are sufficient to vaporize and remove much of the sprayed water, thereby concentrating the binder dispersion and depositing binder on the fibers as a viscous liquid with high solids content. Ventilating blowers create negative pressure below the conveyor and draw air, as well as any particulate matter not bound in the pack, through the conveyor and eventually exhaust it to the atmosphere. The uncured fibrous pack is transferred to a drying and curing oven where a gas, heated air for example, is blown through the pack to dry the pack and cure the binder to rigidly bond the glass fibers together in a random, three-dimensional structure, usually referred to as a “blanket.” Sufficient binder is applied and cured so that the fibrous pack can be compressed for packaging, storage and shipping, yet regains its thickness—a process known as “loft recovery”—when compression is removed.

While manufacturers strive for rigid process controls, the degree of binder cure throughout the pack may not always be uniform for a variety of reasons. Irregularities in the moisture of the uncured pack, non-uniform cross-machine weight distribution of glass, irregularities in the flow or convection of drying gasses in the curing oven, uneven thermal conductance from adjacent equipment like the conveyor, and non-uniform applications of binder, among other reasons, may all contribute to areas of over- or under-cured binder. Thus it is desirable to test for these areas in final product to assure quality, and to adjust the process controls, if necessary, to maintain the process within the control limits.

U.S. Pat. No. 3,539,316 to Trethewey and U.S. Pat. No. 4,203,155 to Garst both describe curing ovens in which a thermocouple is installed inside the curing oven and is used to provide feedback to the heater control to make adjustments if the sensed temperature is not at a predetermined setpoint. While useful, this approach has drawbacks in that the thermocouple senses the generalized oven air temperature and gives no information about the pack temperature where the binder is located, and therefore no information about cure status.

U.S. Pat. No. 7,781,512 to Charbonneau, et al, describes two mechanisms for monitoring the cure status of formaldehyde-free glass fiber products. In the first embodiment, one or more spectrographic sensors, such as an infrared sensor, detect the radiant energy from the pack upon exit from the oven. In a second embodiment, thermocouples are placed directly into the pack prior to entering the oven, and the signals are led by wires to an external device or to a transportable storage device such as a M.O.L.E® recorder (although the term “oven mole” is often used generically). Upon exit, data collected in the storage device is uploaded and in all cases, the measured temperatures are compared to standard values to determine cure.

These methods also have drawbacks. While a “mole” provides a good estimate of the actual pack temperature, it has several disadvantages. First, it measures the temperature at only one location of the pack, testing only a sampling of the product. Second, it must be inserted prior to the oven and removed after the oven, and this involves a labor intensive manual process. Third, it does not provide real-time data; the storage device is removed and evaluated, but this is long after the pack has emerged so the data cannot effectively be used as a means to adjust any process parameters. Finally, it provides data only for as long as the pack is in the oven. In other words, the data it provides is not continuous. On the other hand, infrared surface measurements may be continuous, but are less useful as process controls when measured after exit from the oven, and when taken from just a single (top usually) surface.

The present invention seeks to overcome these disadvantages and to provide a means to maintain the process within control limits.

### SUMMARY OF THE INVENTION

The invention relates to and apparatus and improved methods for continuously monitoring cure status of binder on a fibrous product and controlling the operation parameters or variables within defined control limits to improve product outcomes. In one aspect, the invention in an apparatus for controlling the cure status of binder applied to a fibrous product manufactured in a manufacturing line, the apparatus comprising:
a curing oven having at least two zones with blowers for circulating heated gas through the oven zones, manipulatable controls for varying at least one operating parameter of the manufacturing line;
a first sensor for generating a first signal indicative of the cure status of the fibrous product, and a distinct second sensor for generating a distinct second signal indicative of the cure status of the fibrous product;
a processor for receiving the first and second signals from the first and second sensors and generating at least one control signal for adjusting at least one of the manipulatable controls of the manufacturing line in response to the first and second signals indicative of the cure status.

In another aspect, the invention is a method for controlling the cure status of binder in a fibrous product manufactured on a manufacturing line including a curing oven and manipulatable controls for the operating parameters of the manufacturing line, the method comprising:
sensing at least one first control variable indicative of the cure status of the fibrous product, and generating a first signal indicative of the cure status;
sensing at least one distinct second control variable indicative of the cure status of the fibrous product, and generating a distinct second signal indicative of the cure status;
inputting the first and second signals to a MPC processor-optimizer capable of solving for optimal control conditions, given predetermined constraints for the control variables and an optimizing function; and
generating at least one output control signal from the MPC processor-optimizer to adjust at least one of the manipulatable controls of the manufacturing line in response to the optimal condition.

The optional features described in this paragraph may be present in either the apparatus or the method aspect of the invention. The manipulatable controls may be selected from oven zone fan speeds, oven zone setpoint temperatures and coolant water flow. Either or both of the first and second sensors may independently be a thermocouple for sensing a temperature, or an image capture system for capturing an image such as a color value. There may be more than just two sensors; indeed there may be a plurality of sensors. For example, there may be multiple thermocouples disposed throughout the various zones of an oven as described in detail herein, some entry, some egress; some inlet, some outlet; some top, some bottom. There may be multiple regions of interest (ROI) from which color values may be taken, and the color values may be any of those described herein, such as a color B value. The signals generated by any combination of similar sensors may be manipulated by processors or comparators to form average or differential values, for both temperatures and/or color values from an image capture system, regardless of the location of the sensor. The system may further comprise a ramp height sensor at a location prior to entering a first oven zone, and this information may also be input to the (MPC) processor for consideration in the optimization procedure.

In at least one embodiment, the apparatus comprises a plurality of sensors, each generating a respective signal indicative of the cure status of the fibrous product, and wherein: at least one sensor comprises a thermocouple; at least one sensor comprises an image capture system; and at least one sensor comprises a ramp height sensor. And in at least one method, each of these three (or more) signals is input to the MPC optimizer to generate a control signal for a manipulatable variable, such as oven zone fan speeds, oven zone setpoint temperatures and coolant water flow

A primary feature of the present invention is to provide “continuous” or “on-line” measurements of feedback variables that represent cure status, and to utilize those measured variables to maintain “control” over the process for forming a bindered fibrous product. By “online” is meant that the measurements can be taken without removing a sample of the fibrous product from the manufacturing line. Online measurements are continuous in the case of thermocouples and video images, and essentially continuous for captured images in that every batt can be sampled if desired without destruction or loss of line speed; although each captured image remains a still photo or snapshot.

Another feature is the ability to select which variables to control for and to prioritize them for consideration by a dynamic optimizer processor.

Other advantages and features are evident from the following detailed description.

### BRIEF DESCRIPTION OF THE DRAWINGS

The accompanying drawings, incorporated herein and forming a part of the specification, illustrate the present invention in its several aspects and, together with the description, serve to explain the principles of the invention. In the drawings, the thickness of the lines, layers, and regions may be exaggerated for clarity.

FIG. 1 is a partially sectioned side elevation view of a forming hood component of a manufacturing line for manufacturing fibrous products;

FIG. 2 is a schematic illustration representing the curing oven and its several zones and locations of thermocouples in the oven zones for one embodiment;

FIG. 3 is a schematic illustration representing two oven zones, a processor, and thermocouple locations and nomenclature for one embodiment;

FIG. 4A is a front view of a camera system installed over a manufacturing line; FIG. 4B is a side view of this system;

FIG. 5 is a block diagram representing the steps of one process embodiment according to the invention; and

FIG. 6 is schematic representation of the steps of involved in using a MPC processor for dynamic optimization of a manufacturing process.

Various aspects of this invention will become apparent to those skilled in the art from the following detailed description of the preferred embodiment, when read in light of the accompanying drawings.

### DETAILED DESCRIPTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are described herein. All references cited herein, including books, journal articles, published U.S. or foreign patent applications, issued U.S. or foreign patents, and any other references, are each incorporated by reference in their entireties, including all data, tables, figures, and text presented in the cited references.

Unless otherwise indicated, all numbers expressing ranges of magnitudes, such as angular degrees or web speeds, quantities of ingredients, properties such as molecular weight, reaction conditions, dimensions and so forth as used in the specification and claims are to be understood as being modified in all instances by the term “about.” Accordingly, unless otherwise indicated, the numerical properties set forth in the specification and claims are approximations that may vary depending on the desired properties sought to be obtained in embodiments of the present invention. Notwithstanding that the numerical ranges and parameters setting forth the broad scope of the invention are approximations, the numerical values set forth in the specific examples are reported as precisely as possible. Any numerical values, however, inherently contain certain errors necessarily resulting from error found in their respective measurements. All numerical ranges are understood to include all possible incremental sub-ranges within the outer boundaries of the range. Thus, a range of 30 to 90 degrees discloses, for example, 35 to 50 degrees, 45 to 85 degrees, and 40 to 80 degrees, etc.

“Binders” are well known in the industry to refer to thermosetting organic agents or chemicals, often polymeric resins, used to adhere glass fibers to one another in a three-dimensional structure that is compressible and yet regains its loft when compression is removed. “Binder delivery” refers to the mass or quantity of “binder chemical” e.g. “binder solids” delivered to the glass fibers. This is typically measured in the industry by loss on ignition or “LOI,” which is a measure of the organic material that will burn off the fibrous mineral. A fibrous pack is weighed, then subjected to extreme heat to burn off the organic binder chemical, and then reweighed. The weight difference divided by the initial weight (x 100) is the % LOI.

As solids, rate of binder delivery is properly considered in mass/time units, e.g. grams/minute. However, binder is typically delivered as an aqueous dispersion of the binder chemical, which may or may not be soluble in water. “Binder dispersions” thus refer to mixtures of binder chemicals in a medium or vehicle and, as a practical matter, delivery of binder “dispersions” is given in flow rate of volume/time. e.g. liters/minute or LPM of the dispersion. The two delivery expressions are correlated by the mass of binder per unit volume, i.e. the concentration of the binder dispersion. Thus, a binder dispersion having X grams of binder chemical per liter flowing at a delivery rate of Z liters per min delivers X*Z grams/minute of binder chemical. Dispersions include true solutions, as well as colloids, emulsions or suspensions.

References to “acidic binder” or “low pH binder” mean a binder having a dissociation constant (Ka) such that in an aqueous dispersion the pH is less than 7, generally less than about 6, and more typically less than about 4.

Fibrous products are products made from a plurality of randomly oriented fibers. The fibers are generally bound in place by binders, described above. “Mineral fibers” refers to any mineral material that can be melted to form molten mineral that can be drawn or attenuated into fibers. Glass is the most commonly used mineral fiber for fibrous insulation purposes and the ensuing description will refer primarily to glass fibers, but other useful mineral fibers include rock, slag and basalt. Polymer fibers are fibers of any thermoplastic materials, for example as polyvinyls or polyesters like polyethylene, polypropylene and their terephalate derivatives.
“Product properties” refers to a battery of testable physical properties that insulation batts possess. These may include at least the following common properties:
“Recovery”—which is the ability of the batt or blanket to resume it's original or designed thickness following release from compression during packaging or storage. It may be tested by measuring the post-compression height of a product of known or intended nominal thickness, or by other suitable means.
“Stiffness” or “sag”—which refers to the ability of a batt or blanket to remain rigid and hold its linear shape. It is measured by draping a fixed length section over a fulcrum and measuring the angular extent of bending deflection, or sag. Lower values indicate a stiffer and more desirable product property. Other means may be used.
“Tensile Strength”—which refers to the force that is required to tear the fibrous product in two. It is typically measured in both the machine direction (MD) and in the cross machine direction (“CD” or “XMD”).
“Lateral weight distribution” (LWD or “cross weight”)—which is the relative uniformity or homogeneity of the product throughout its width. It may also be thought of as the uniformity of density of the product, and may be measured by sectioning the product longitudinally into bands of equal width (and size) and weighing the band, by a nuclear density gauge, or by other suitable means.
“Vertical weight distribution” (VWD)—which is the relative uniformity or homogeneity of the product throughout its thickness. It may also be thought of as the uniformity of density of the product, and may be measured by sectioning the product horizontally into layers of equal thickness (and size) and weighing the layers, by a nuclear density gauge, or by other suitable means.

Of course, other product properties may also be used in the evaluation of final product, but the above product properties are ones found important to consumers of insulation products.

### General Fiberizing Process

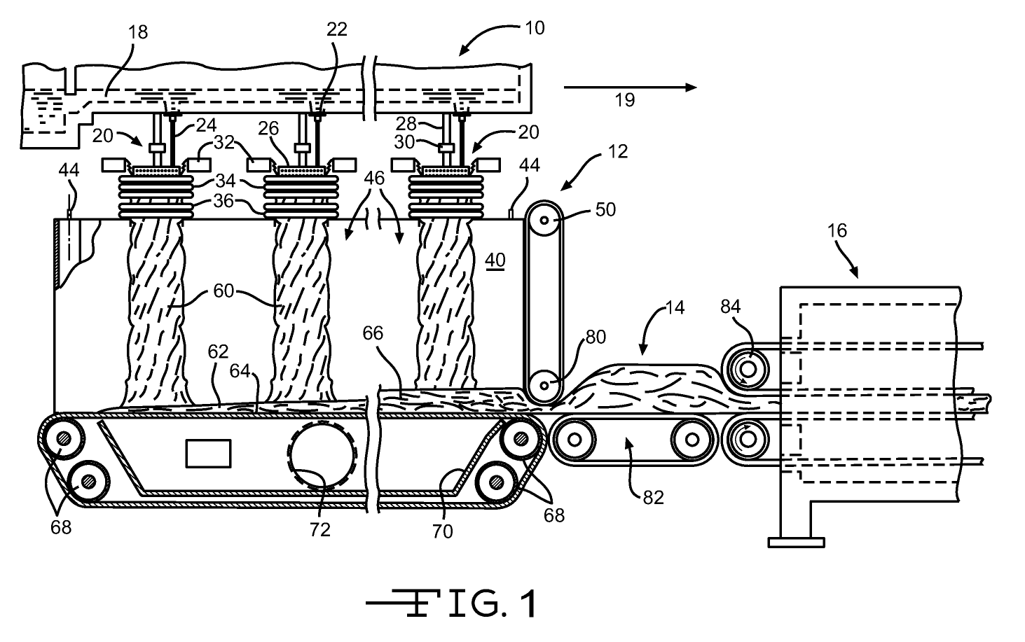

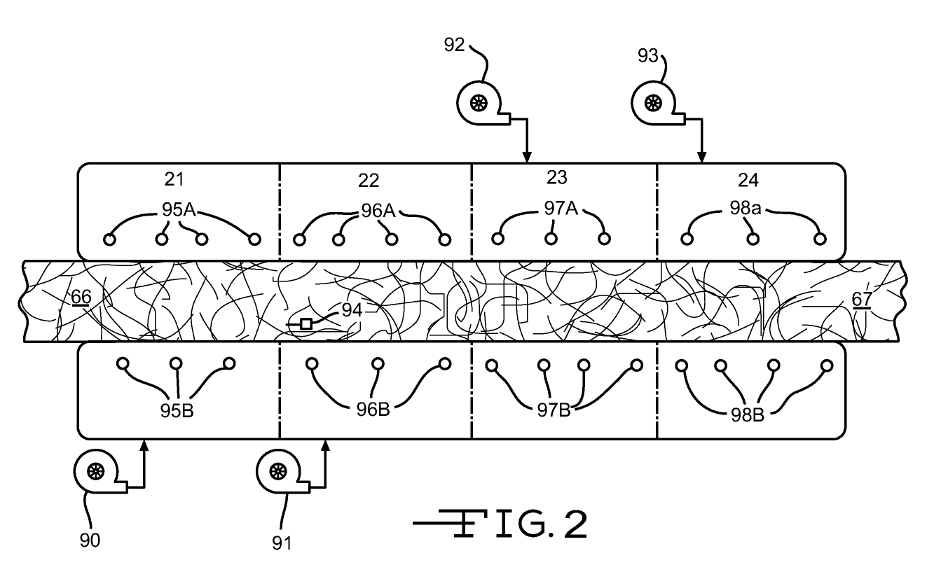

FIG. 1 illustrates a glass fiber insulation product manufacturing line including a forehearth 10, forming hood component or section 12, a ramp conveyor section 14 and a curing oven 16. Molten glass from a furnace (not shown) is led through a flow path or channel 18 to a plurality of fiberizing stations or units 20 that are arranged serially in a machine direction, as indicated by arrow 19 in FIG. 1. At each fiberizing station, holes 22 in the flow channel 18 allow a stream of molten glass 24 to flow into a spinner 26, which may optionally be heated by a burner (not shown). Fiberizing spinners 26 are rotated about a shaft 28 by motor 30 at high speeds such that the molten glass is forced to pass through tiny holes in the circumferential sidewall of the spinners 26 to form primary fibers. Blowers 32 direct a gas stream, typically air, in a substantially downward direction to impinge the fibers, turning them downward and attenuating them into secondary fibers that form a veil 60 that is forced downwardly. The fibers are distributed in a cross-machine direction by mechanical or pneumatic “lappers” (not shown), eventually forming a fibrous layer 62 on a porous conveyor 64. The layer 62 gains mass (and typically thickness) with the deposition of additional fiber from the serial fiberizing units, thus becoming a fibrous “pack” 66 as it travels in a machine direction 19 through the forming area 46.

One or more cooling rings 34 spray coolant liquid, such as water, on veil 60 to cool the fibers within the veil. Other coolant sprayer configurations are possible, of course, but rings have the advantage of delivering coolant liquid to fibers throughout the veil 60 from a multitude of directions and angles. Flow of coolant water through an applicator or spray device such as the rings 34 is one example of a manipulatable variable as described in more detail below. A binder dispensing system includes binder sprayers 36 to spray binder onto the fibers of the veil 60. Illustrative coolant spray rings and binder spray rings are disclosed in US Patent Publication 2008-0156041 A1, to Cooper. Each fiberizing unit 20 thus comprises a spinner 26, a blower 32, one or more cooling liquid sprayers 34, and one or more binder sprayers 36. FIG. 1 depicts three such fiberizing units 20, but any number may be used. For insulation products, typically from two to about 15 units may be used in one forming hood component for one line.

The forming area 46 is further defined by side walls 40 and end walls 48 (one shown) to enclosed a forming hood. The side walls 40 and end walls 48 are each conveniently formed by a continuous belt that rotates about rollers 44 or 50, 80 respectively. The terms “forming hoodwall”, “hoodwall” and “hood wall” may be used interchangeably herein. Inevitably, binder and fibers accumulate in localized clumps on the hoodwalls and, occasionally, these clumps may fall into the pack and cause anomalous dense areas or “wet spots” that are difficult to cure.

The conveyor chain 64 contains numerous small openings (encompassing e.g. approximately 50% of the area) allowing the air flow to pass through while links support the growing fibrous pack. A suction box 70 connected via duct 72 to fans or blowers (not shown) are additional production components located below the conveyor chain 64 to create a negative pressure and remove air injected into the forming area. As the conveyor chain 64 rotates around its rollers 68, the uncured pack 66 exits the forming section 12 under exit roller 80, where the absence of downwardly directed airflow and negative pressure (optionally aided by a pack lift fan, not shown) allows the pack to regain its natural, uncompressed height or thickness s. A subsequent supporting conveyor or “ramp” 82 leads the fibrous pack toward an oven 16 and between another set of porous compression conveyors 84 for shaping the pack to a desired thickness for curing in the oven 16.

Upon exit from the oven 16, the cured pack or “blanket” is conveyed downstream for cutting and packaging steps. For many products, the blanket is sectioned or “split” longitudinally into multiple pieces or lanes of standard width dimension, for example, 14.5 inch widths and 22.5 inch are standardized to fit in the space between 2×4 studs placed on 16 inch or 24 inch centers, respectively. Other standard widths may also be used. A blanket may be 4 to 8 feet in width and produce multiple such standard width pieces.

Blankets are typically also sectioned or “chopped” in a direction transverse to the machine direction for packaging. Transverse chopping divides the blanket lanes into shorter segments known as “batts” that may be from about 4 feet up to about 12 feet in length; or into longer, rolled segments that may be from about 20 feet up to about 175 feet or more in length. These batts and rolls may eventually be bundled for packaging. A faster-running takeup conveyor separates one batt from another after they are chopped to create a space between sectioned batt ends. If longitudinal “lanes” are desired, they generally are split prior to chopping into shorter lengths.

### Oven Zones and Thermocouples

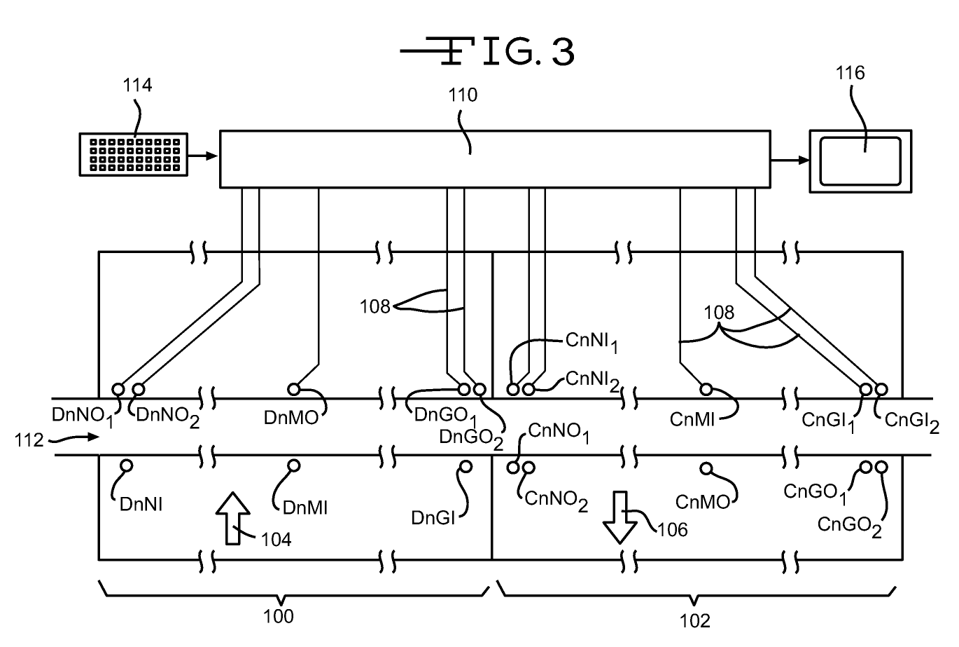

The curing oven applies heated gas, typically air, and circulates it through the fibrous pack to dry and cure it. When fibrous products are formed with accompanying moisture, the moisture must be removed (i.e. the product must be dried) before it will reach the critical temperature necessary to cure binder. Conveniently, the oven may be divided into at least two zones, a drying zone and a curing zone, and each of these may be further subdivided into subzones. Each “zone” or “subzone” as used herein will have separate and distinct controls for temperature setpoints and blower or fan speeds. As discussed in more detail below, both the temperature and the flow rate of the heated gas (air) are manipulatable variables. FIGS. 2 and 3 are schematic representations of ovens with zones and/or subzones.

FIG. 2 is a schematic diagram representing an oven 16 which typically may include four distinct (sub)zones, Z1, Z2, Z3 and Z4. The zones are designed to carry out multiple processes. In zones #1 and #2, fans 90, 91 blow a stream of warmed air upwards through the pack 66; while in zones #3 and #4, fans 92, 93 blow a stream of warmed air downwards through the pack 66. Zones #1 and #2 may be thought of as “drying” subzones, while zones #3 and #4 may be thought of as “curing” subzones. The choice of up-versus down draft is a matter of preference, but upward is often used first to help counteract the downward suction force present in the forming hood.

The air is heated by any suitable means, such as gas burners (not shown) associated with each zone to a temperature in the range of from about 400 F to about 600 F. In some embodiments, drying (sub)zones (e.g. zones #1 and #2) are generally heated to a temperature setpoint of about 400 F to about 450 F, while curing (sub)zones (e.g. zones #3 and #4) are generally heated to a temperature setpoint from about 430 F to about 550 F.

Oven controls include controls (not shown) for increasing or decreasing the temperature and/or fan speed of each oven zone independently. In order to monitor the temperature of the oven, thermocouples may be installed to compare the actual oven temperature to the setpoint.

The present invention goes beyond this however, to provide an apparatus and method for continuously monitoring temperatures at various locations throughout the oven, and manipulating these measurements to obtain useful information about the pack temperature and cure state. While some of these are approximations of the pack temperature, good correlation has been found to exist with empirical data. Moreover, these measurements are delivered continuously in real time, so they can be used for process control. This latter point is a key advantage.

In order to cure thermosetting binder in a fibrous pack, the pack must reach a certain critical temperature to initiate and complete the chemical crosslinking or thermoset curing reaction. While the specific critical temperature may vary depending on the nature of the binder, the thickness of the product and other factors, it is generally in the range of from about 200° F. to about 400° F. Energy is put into the pack in the form of heated gas, typically heated air. But so long as moisture exists in the pack, a great deal of the input energy is used up evaporating the water and drying the pack rather than raising its temperature toward the critical temperature. Pack temperature changes little during this drying phase. Once the pack is mostly dry—a point known as “drying time” or “drying distance”—additional energy input does begin to raise the pack temperature toward the critical temperature and the chemical binder begins to crosslink or “cure” in this curing phase. Applicants have found that, by placing multiple thermocouple sensors in various locations in the oven zones, they can obtain useful signals indicative of temperature information from which the timing and status of the drying phase and curing phase can be estimated.

The location of the thermocouple sensors in the ovens is important and some specific terminology is developed to describe the location. Initially, one may identify the zone in which the thermocouple is placed. There are at least two zones, e.g. a drying zone and a curing zone, designated (D) and (C) respectively. If they are divided into subzones, they may be designated by a numeral, e.g. D1, D2, D3 . . . Dn or C1, C2, C3 . . . Cn. Alternatively, when the distinction between a drying zone and a curing zone is not identifiable, multiple zones of subzones may be designated Z1, Z2, Z3 . . . Zn, The four subzones in FIG. 2 are thus labeled Z1, Z2, Z3 and Z4. However, in the description and claims, references to “first”, “second”, “one”, and “another” oven zones or subzones serves only to differentiate one zone from any other zone and does not refer to any particular ordinal position and is explicitly not limited to specific zones #1 and #2. Descriptors like “previous”, prior”, “adjacent”, “later” or “subsequent” do refer to the relative order of zones, but not to any specific unit or position. When a specific oven zone is referenced, the Dn/Cn (or Zn) designation is used.

Within each oven zone, the conveyor 84—often in top and bottom portions—defines a path along which the fibrous pack is carried. The conveyor 84 is again a foraminous web and may be approximately 50% porous and have a thickness of about 0.2 to about 6 inches. The conveyor 84 and the fibrous pack path it defines enter each oven zone at an “entry” and leave each oven zone at an “egress.” Thermocouples may be placed in each zone near the entry, near the egress, or at any intermediate or middle locations along the path between the entry and egress. These locations are given shorthand notations “N” for entry, “G” for egress, and “M” for middle positions. In some embodiments, the thermocouples are relatively linear in the machine direction and approximately along the cross-machine center line of the zone, although they might also be placed non-linearly or in arrays with cross-machine spacing between thermocouples. It should also be understood that in some zones the conveyor chain itself can carry significant heat from a previous zone, and this can compound the analysis of the temperature of the pack near the entries.

Furthermore, thermocouples may be placed above or on top of the conveyor path (T), below the path (B), or both above and below the path (T/B). While ‘above’ and ‘below’ have meaning in the context of gravity, the direction of airflow in any given zone is a more relevant consideration, so it is more useful to think of the thermocouples as being located upstream or downstream of the pack path, sensing an inlet (designated “I”) or outlet (designated “O”) temperature, respectively. For example in upflow zones, thermocouples below the pack sense an “inlet” temperature of the air “upstream” of the pack (i.e. before the air passes through the pack); and thermocouples above the pack sense an “outlet” temperature of the air “downstream” of the pack (i.e. after the passes through the pack). In downflow zones, the reverse is true, the thermocouples above the pack sense inlet temperature while the thermocouples below the pack sense outlet temperatures. In the context of the energy content of the air, upstream or inlet (I) thermocouples always sense higher energy inlet air temperatures, and downstream or outlet (O) thermocouples sense lower temperatures after the pack has absorbed the energy from the heated air.

Thus, the location of each thermocouple may be specified by a series of designator letters (or numbers) that indicated its location in the oven. For a linear array, three designators suffice, although a fourth may be useful for non linear arrays. Since redundant thermocouples may be used at any location for accuracy and safety, a subscript numeral may be added. Table A below indicates some of the possible location designators, although all potential permutations are possible.

TABLE A
Illustrative Location Designators

| Designator | Location description |
|---|---|
| D1NI | at the entry of the first drying zone and upstream of the path |
| | (inlet side) |
| D1NO₁, | a pair of thermocouples both at the entry of a first drying zone |
| D1NO₂, | and downstream of the path (outlet side) |
| D2GI₁, | a trio of thermocouples at the egress of a second drying zone |
| D2GI₂, | and upstream of the path (inlet side) |
| D2GI₃ | |
| Z2GO₁, | a pair of thermocouples both at the egress of a second |
| Z2GO₂, | (unspecified) zone and downstream of the path (outlet side) |
| C2NI | at the entry of a second curing zone and upstream of the path |
| | (inlet side) |
| D2MO₁, | a pair of thermocouples at the middle of a second drying zone |
| D2MO₂ | and downstream of the path (outlet side) |
| C2GO₁, | a pair of thermocouples both at the egress of a second curing |
| C2GO₂ | zone and downstream of the path (outlet side) |
| Z4GO₁, | a quartet of thermocouples both at the egress of a fourth |
| Z4GO₂, | (unspecified) zone and downstream of the path (outlet side) |
| Z4GO₃, | |
| Z4GO₄ | |
| Z3NI | at the entry of the third (unspecified) zone and upstream of the |
| | path (inlet side) |
| Z3MIT | at the middle of a third (unspecified) zone and upstream of the |
| | path (inlet side) which happens to be on top of the path |
| | indicating an downflow zone |
| D1NOT₁, | a pair of thermocouples both at the entry of a first drying zone |
| D1NOT₂, | and downstream of the path (outlet side) which happens to be |
| | on top of the path indicating an upflow zone |
| Z4GOB₁, | a pair of thermocouples both at the egress of a fourth |
| Z4GOB₂, | (unspecified) zone and downstream of the path (outlet side) |
| | which happens to be on bottom of the path indicating an |
| | downflow zone |

A final location consideration is how far the thermocouples are placed above or below the fibrous pack path itself. In general, thermocouples are placed in close proximity to the pack. “Close proximity” as used herein means within a distance that is close enough to differentiate the temperature of the fibrous pack from the temperature of the essentially homogeneous mixture gas (air) within the portion of the oven zone above or below the pack path. Typically this “close proximity” distance is less than about 24 inches, more likely less than about 18 inches or 12 inches, or even less than about 9, inches, 6 inches or 3 inches. The thickness of the conveyor itself plus a margin for mechanical safety will constrain how close a thermocouple can be to fibrous pack.

Thus, as shown in FIG. 2, thermocouples 95A-98A may be installed in the oven above the pack 66, and/or thermocouples 95B-98B may be installed below the pack 66. In each case the thermocouples are in close proximity to the pack 66 and its path along the conveyor 84. Although FIG. 2 represents 3 or 4 thermocouples above and below the pack 66 in each zone, the number may vary from 1 to about 30 in each zone, depending on the cross-sectional area and/or length of the zone.

By placing thermocouples in sets, some above (A) and some below (B) the pack, it is possible to understand how much energy is absorbed by the pack in evaporating the moisture from it or in carrying out the drying and curing reaction. This is advantageous over a mole thermocouple in that real-time pack temperature data is available on a continuous basis. In oven zones #1 and #2, which are depicted as upflow zones, the lower thermocouples 95B and 96B are “upstream” or “inlet” thermocouples since they monitor the inlet temperature of air as it enters the pack; while upper thermocouples 95A and 96A are “downstream” or “exit” thermocouples (in zones #1 and #2) since they monitor the temperature of air as it exits the pack. Conversely, because the flow is reversed in zones 3 and 4, lower thermocouples 97B and 98B can be thought of as “downstream” or “exit” thermocouples and upper thermocouples 97A and 98A can be thought of as “upstream” or “inlet” thermocouples. Furthermore, it can be observed that in zone #1, the outlet thermocouples 95A are near the entry of zone #1, while in zone #2, the outlet thermocouples are near the egress of zone #2.

An embedded thermocouple or “mole” is depicted at 94.

The actual thermocouples used may be any of a wide variety designed to operate at the temperatures of the curing ovens. Suitable thermocouples include those made of alloys of metals, primarily nickel, copper, aluminum and chromium (some with minor amounts of silicon and/or manganese, for example chromel, alumel and constantan) having sensitivities varying from about 40 μV to about 60 μV per ° C. change. Thermocouples are generally graded with a letter indicating type. Types K and J have been found suitable, J having generally higher sensitivity.

### Temperature Variables

FIG. 3 schematically illustrates an oven with two zones: a drying zone 1 (100) and curing zone 2 (102). Drying zone 1 is an upflow zone as shown by arrow 104; and curing zone 2 is a downflow zone as shown by arrow 106. A series of thermocouples are shown in each oven zone, each thermocouple being identified using the location designation nomenclature described above. Thermocouple conductor leads 108 connect the thermocouples to a processer unit 110. For clarity, the conductor leads 108 are shown only for thermocouples located above the path 112, it being understood that thermocouples below the path 112 are similarly connected to the processor 110. An input device 114, such as a keyboard, touchpad, touchscreen, mouse or the like, may optionally be provided to program or provide other information to the processor. An output device 116, such as a printer, display monitor, speaker or the like, may also be connected to the processor. The input device 114 and output device 116 are adapted to provide interfaces, for example, visual, audible, tactile or other interfaces.

While absolute temperatures may be useful, comparisons are typically more useful. Processor circuitry and components suitable for comparing the thermocouple outputs are standard in the industry and need not be described in detail herein. In general, two types of comparisons are useful: temperature averages and temperature difference, which includes the difference between an absolute temperature and a standard. However, the information gleaned from these will vary depending on the location of thermocouples whose outputs are compared. With reference to FIGS. 3-5, Table B describes some averaging comparisons and some difference comparisons that have proven useful.

TABLE B
Illustrative Thermocouple Comparisons

| | |
|---|---|
| Comparison | Interpretation/Explanation |

Averages

| | |
|---|---|
| DnNO₁ and | averaging two or more thermocouples in the same |
| DnNO₂ or | location provides redundancy safety and greater accuracy |
| DnGO₁ and | due to potential miscalibrations; this may also be useful |
| DnGO₂ or | in non-linear arrays having multiple temperature readings |
| CnGO₁ and | in a cross machine direction. |
| CnGO₂ | |
| DnNO and | averaging two or more thermocouples in different linear |
| DnGO and | positions across the same zone or subzone provides |
| optionally | information about the average pack temperature across the |
| with DnMO | zone; this may be useful in comparison to the oven zone |
| | setpoint or as used in differences (see below) |

Differences

| | |
|---|---|
| D1NI and | differences in temperature from upstream (inlet) side to |
| D1NO or | downstream (outlet) side provide information about the |
| DnGI and | moisture content in the drying zones or subzones; the |
| DnGO or | more moisture, the greater the amount of evaporation and |
| DnNI and | the greater the temperature difference. This may be |
| DnGO | compared at any linear position or across the entire zone |
| | or subzone. It is especially useful at the first entry |
| | position, giving a measure of the initial pack moisture. |
| DnNO and | outlet differences from entry to egress in a drying zone |
| DnGO or | or subzone suggest the extent of drying. Generally, outlet |
| especially | temperature rises gradually across a zone or subzone as |
| D1NO and | more moisture is removed. This is also useful across |
| D2GO | multiple drying zones, or in multiple iterations as a |
| | temperature profile from a starting point |
| CnNI and | differences in temperature from upstream (inlet) side to |
| CnGO | downstream (outlet) side in the curing zone or subzone |
| | provide information about the extent of curing; generally |
| | this difference is fairly small compared to differences in |
| | the drying zones/subzones |
| CnNO and | outlet differences from entry to egress in a curing zone or |
| CnGO, | subzone suggest the extent of curing. If there is a |
| C3NO and | substantial difference here, it could indicate some drying |
| C4GO or | is still taking place. |
| D1NO to | Additionally, the entire differential profile throughout |
| C4GO | the oven, e.g. from D1 to Cn is useful for monitoring cure |
| | as it provides assurance of adequate pack cure temperature |
| | sustained for an adequate duration of time. |
| CnGO and | It has been found that if a particular temperature is |
| a standard | achieved for a sufficient duration of time in a curing zone |
| temperature | or subzone, the product will be well cured. This |
| determined | temperature depends on the particular manufacturing line |
| from empir- | and product (e.g. R-value, thickness, density, binder type |
| ical work | and load, etc) but can be determined empirically. |

As noted in Table B above, applicants have found that difference between the outlet temperature in zone #1 near the entry and the outlet temperature in zone #2 near the egress (delta T) can be used to infer moisture drying rate in the pack. This is an important one of several possible temperature variables. A second useful temperature variable is derived from the entry temperatures (inlet and outlet) in zone #1. For a given inlet entry temperature the resultant outlet entry temperature is suggestive of how much initial moisture is present in the pack to absorb energy; the greater this difference, the higher the moisture level. A third possible temperature variable is the difference between inlet and outlet thermocouple pairs throughout the drying phase or drying distance (typically zones #1 and #2) and also throughout the curing phase, (e.g. zones #3 and #4). Within each zone the paired thermocouple difference generally diminishes moving from entry to egress as moisture is evaporated. When this difference reaches a sufficiently small threshold value, one may conclude the pack is essentially dried and the remaining energy absorption is attributed to the chemical curing reaction. This is another inference of drying distance. Another useful temperature variable is the outlet temperature in the oven zone, which can be used to estimate the pack temperature once the pack is dry.

While each comparison described in Table B above is binary, compound comparisons are also encompassed. For example, taking the difference of two averaged readings, or combining the initial inlet-outlet difference with the entry-egress outlet differences in a complex comparison. Of course, it is to be understood that all such arithmetic manipulations of two or more signals or values is necessarily encompassed by the step of sensing “at least one” variable, since at least two must be sensed for comparisons.

Methods of use of the present invention involve taking the thermocouple signals (or the temperatures they represent) during a manufacturing run and comparing them in various ways as described above to assess the cure status of the fibrous blanket. This method is described in more detail below. Furthermore, the thermal information obtained from the oven thermocouples may be used alone or in combination with other measurements to assess cure. Some other possible measurements include, for example, tactile, visual and pH measurements as disclosed in co-owned provisional application Ser. No. 61/421,295 filed Dec. 9, 2010.

### Color Value Variables and Detection System

Another variable useful for monitoring cure is a color value as part of a color system as disclosed in application Ser. No. 13/089,457 filed Apr. 19, 2011, which is incorporated herein by reference. A color system variable may be monitored continuously by capturing video or sequential images of cut sections of the blanket as it proceeds down the line from oven to packaging. The image capture system constitutes a sensor that generates a signal indicative of sure status.

Blankets of glass fiber products exiting the oven may be cut or “sectioned” into multiple pieces. As used herein, the term “section” is any cut into the interior of the blanket and in most cases is a straight or planar cut. However, the term “section” (and its derivatives like “sectioned” or “sectioning”, etc.) includes cuts in any direction, including cuts that are parallel to the planes defined by the conventional orthogonal axes (X=machine direction, Y=cross-machine direction, and Z=height) and cuts that are not. A sectioned face that lies generally in the X-Z plane is also known as a longitudinal “split” and generally defines the “lanes” of specific width. In contrast, a section that lies generally in the Y-Z plane is also known as a “chopped” section. The term “end face” encompasses either the leading or terminal face of a chopped blanket. For completeness, a section may also include cuts in the X-Y plane or in planes not aligned with the XYZ axes.

As further described in application Ser. No. 13/089,457, any section can be “virtually” divided into multiple regions of interest (“ROIs), potentially in a grid format. For example, in an end-face chopped section, three ROIs in the Z direction might be designated T, M and B for top, middle and bottom; and four ROIs in the Y direction (designated, for example, L1, L2, L3 and L4) may, but do not have to, correspond to longitudinal lanes as described above. Thus, each ROI may be described using row/column coordinates, much like a spreadsheet. In addition to the twelve ROIs produced by the exemplary description above, there may be two side or edge regions, perhaps designated S1 on the left and S2 on the right of the blanket. It is generally desirable to cut away and recycle side edges like this. Any number of ROIs may be utilized.

Many different color system variables are suitable for use with the invention. Due to physiological idiosyncrasies of the eye (sensitivity is not uniform across all wavelengths) there have been many different attempts to quantify color as humans perceive it, the details of which are not essential to the invention. However, some of the useful color space systems and the color system variables they utilize are set forth in the following table C.

TABLE C
Color Systems, Variables and Descriptors

| Name | Description | Color system variables |
|---|---|---|
| RGB | Color encoding scheme | red, green and blue (RGB) |
| | | color |
| HSL | Color encoding scheme | Hue, Saturation, and Lumi- |
| | | nance |
| HSV | Color encoding scheme | Hue, Saturation, and Value |
| HSI | Color encoding scheme | Hue, Saturation, and, Inten- |
| | | sity |
| Hunter | Color encoding scheme | L (perceived luminosity); |
| LAB | based on knowledge that | A (color position between |
| | eye reacts more to | red/magenta and green); and |
| | luminance than hue | B (color position between |
| | | yellow and blue) |
| CIE | Color encoding scheme that | x, y, z corresponding to |
| XYZ | transforms RGB system to | hue, chroma and lumnosity |
| | one using only positive | |
| | values | |
| CIE | Color encoding scheme that | L or L* (perceived lumi- |
| L*a*b* | modifies Hunter according | nosity); A or a* (color |
| or | to the human vision system | position between red/magenta |
| CIELAB | by mimicking the logarithmic | and green); and B or b* |
| | response of the eye | (color position between |
| | | yellow and blue) |
| CIE | Color encoding scheme that | L* (perceived luminosity); |
| L*u*v* | classifies colors according | u* (chroma); and v* (hue); |
| or | proportional perceptual | like XYZ |
| CIELUV | differences | |
| YIQ | For TV broadcasting, linear | Y is similar to perceived |
| | transform of RGB assigning | luminance, I and Q carry |
| | greater bandwidth to | color information and some |
| | luminance | luminance information |

CIE stands for Commission internationale de l'éclairage, or the International Commission on Illumination.

Many if not all of the color system variables for above systems can be mathematically derived from the values of other systems. This facilitates measurements, since only one set of values need be measured, for example RGB, and many of the other color system variables can be calculated. Multiple measurements may take into consideration all the color system variables of the system or a subset of all the values. The LAB systems have been found particularly useful, and one can measure and use all three values: L (perceived luminosity); A (a color position between red/magenta and green); and B (a color position between yellow and blue); just one value, such as the L, A or B value; or a combination of two values.

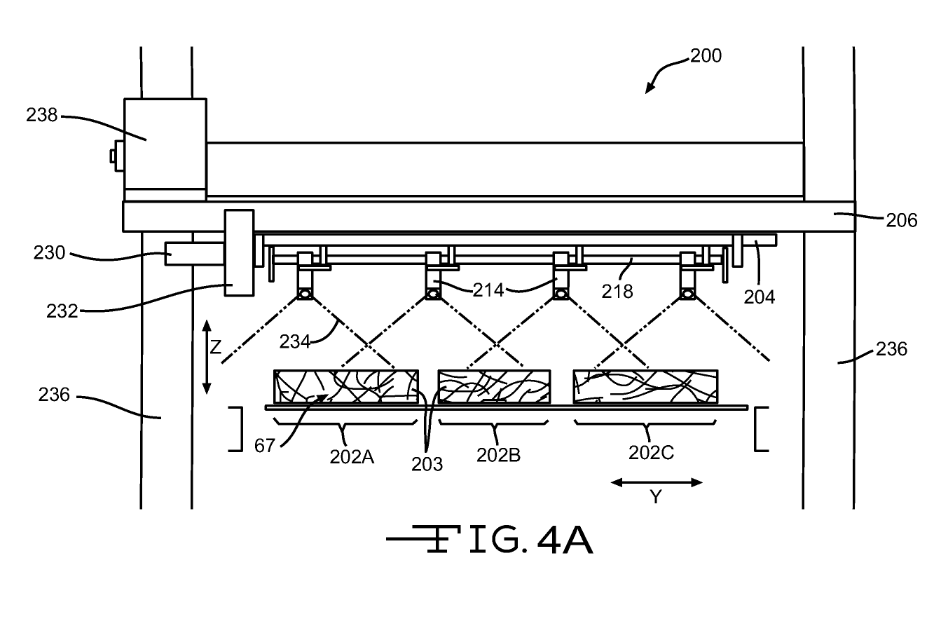

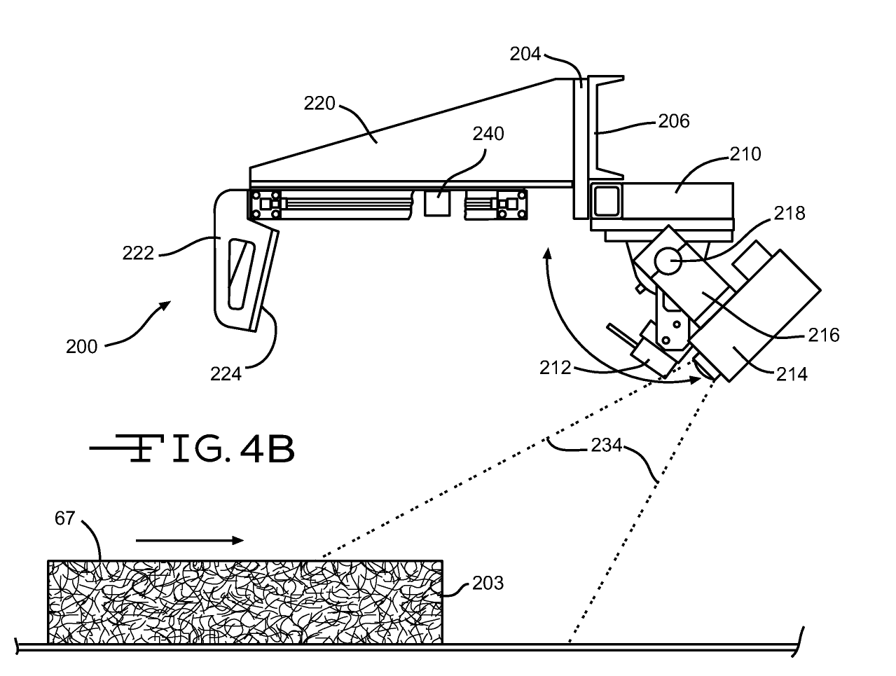

FIGS. 4A and 4B illustrate an image capture system 200 for capturing the image mentioned above. Upon exit from the oven 16, the cured blanket 67 is led past this image capture system 200, typically under it. As noted above, longitudinal splits may divide the blanket in to multiple lanes as represented by lanes 202A, 202B, and 202C. A mounting bracket 204 is suspended from a horizontal rail 206 extending over the manufacturing line. The bracket 204 has two ends. A first end (to the right in FIG. 4B) includes a camera arm 210, on which are secured illumination lights 212 and at least one camera 214. A second end of the mounting bracket 204 includes a calibration arm 220 on which is mounted a calibration plate 222 having a calibration surface 224 facing the camera 214. Either the camera arm 210 or the calibration plate 222, or both, is pivotably mounted so that it is permitted to swing upward/downward to place the calibration surface 224 into the view of the camera 214 for calibrating the camera. In FIG. 4B, a pivot bracket 216 is pivotably mounted to the camera arm 210 and pivots about pivot shaft 218, so that the camera 214 can swing upward to capture a calibration image from the calibration plate surface 224. Motor 230 and gear box 232 are coupled to pivot shaft 218 to cause the rotation that pivots the cameras 214. The angle of view of each camera is represented by lines 234 extending from the camera lens which, depending on the thickness of the blanket 67, may overlap as shown.

Although a single camera is shown in FIG. 4B and described herein, the image capture system 200 may comprise an array of multiple cameras arranged side by side in the Y direction, as shown in FIG. 4A to capture the image of the sectioned face 203 across the entire width of the blanket 67 in the Y direction, as well as the entire height in the Z direction. For example, a blanket of 4-6 feet in width may utilize 3 to 6 cameras, with sufficient lights 212 to capture a suitable image. Support towers 236 elevate the image system 200 above the manufacturing line as needed, and a control panel 238 may be installed on one side or the other. Additional brackets, arms and calibration plates may be added as needed to support the cameras and lights. The mounting brackets and arms may be any suitable material, such as stainless steel or aluminum, for suspending the required equipment.

Mounted on the bracket 204 (shown behind a cutaway section of support strut) is a laser height sensor 240. This detects the height of the blanket, which may vary depending on the desired R value, and sends a binary (on/off) signal to a processor (not shown). When the height of the blanket is above a preset threshold, the sensor 240 sends the “on” signal; but when the height drops below the threshold (e.g. to zero relative to the conveyor, as when a gap between chopped batts is encountered), the sensor 240 sends an “off” signal to the processor. Either change (from off to on, or from on to off) can be used to trigger the camera 214 to capture an image, depending on the camera configuration. The end face 203 may be the trailing edge of a batt that has already passed, for which the on-to-off sensor signal change triggers the camera. Alternatively, the end face 203 may be the leading edge of a batt that is about to pass as depicted in FIG. 4B, and the sensor off-to-on signal change triggers the camera. In either case, the angle of the camera 214 and the distance of the height sensor 240 from the blanket are coordinated to ensure that the camera captures an image of the sectioned end face 203. Any suitable gap or height or interruption sensor could be used in place of a laser sensor 240.

The illuminating lights 212 may comprise any means of illumination, including but not limited to incandescent, fluorescent and light emitting diodes (LED). They may be configured to be constantly on or they can be configures to flash or “strobe” in combination with the camera trigger. The color of “white” light is very subjective, thus the need for “white balancing” or color calibration of the cameras. However, it is desirable for the illumination to remain as constant as possible over time and temperature to minimize recalibration. The more the color or intensity shifts, the more frequently the cameras must be calibrated. Suitable illumination was obtained from Model L300 Linear Connect-a-Light available from Smart Vision Lights, Muskegon, Mich.; or from model number HBR-LW16, white LED light made by CCS America, Burlington, Mass. In some cases, one or two light bars were utilized. In some embodiments, the lights pivot with the camera, while in other embodiments, the lights are stationary.

The camera 214 in some embodiments is a charge coupled device (CCD) digital color camera. Resolution is not critical; successful operation was achieved with resolutions of 480×640 as well as 1024×760, 1296×966, and 1392×1040. Manufacturers of suitable cameras include Sony, Hitachi, Basler, Toshiba, Teledyne Dalsa, and JAI.

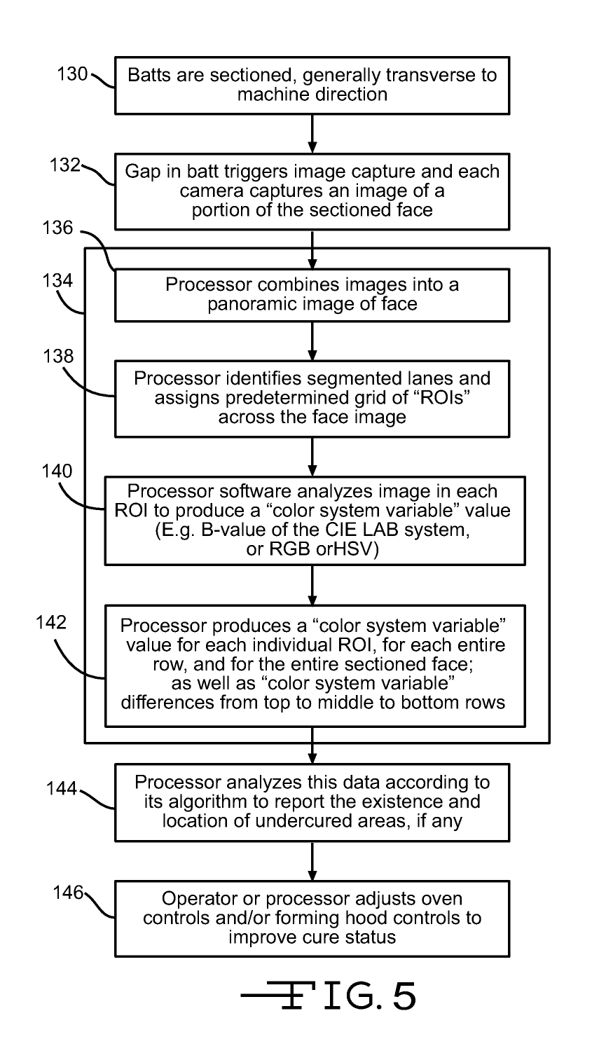

Various image processing software packages are commercially available and it is believed that many would be suitable for use with the invention. Exemplary image processing software programs include those from Cognex, Matrox, National Instrument, and Keyence. The generalized steps that the software may perform are set forth in a portion of the block diagram of FIG. 5. As mentioned above and represented by block 130, the blanket, or longitudinal slices thereof, are sectioned transversely to create leading and trailing end faces. The gap in blanket height triggers the camera or cameras to capture an image of the end face, block 132. This image is fed to a processor represented by block 134 where the software performs a suitable analysis of the image. If necessary, the processor combines multiple images into one panoramic view (block 136). If longitudinal sections are already cut into the blanket, the processor can identify the edges of the longitudinal sections and create boundaries of the image that correspond to the longitudinal lanes. The processor also overlays a grid of regions of interest (ROIs) onto the image, block 138. There should be at least 2 vertical ROIs for comparison, and preferably at least 3 ROIs in a vertical or Z direction. Horizontally (i.e. in the Y direction) there may be one or more ROIs. The Y-direction bounds of the ROI may correspond exactly to the segmented lanes, or there may be a plurality of horizontal ROIs per lane of the image. As mentioned above, FIG. 3 illustrates 9 total ROIs: 3 in the horizontal direction and 3 in the vertical direction.

The processor then analyzes each ROI to obtain a value for at least one color system variable, block 140. A wide variety of color system variables are useful and some are described below. The B-value is one color system variable that has been found suitable for monitoring the cure state of fibrous insulation products and is described herein as one example; although a variety of other color system variables might also be used. At least one color system variable is obtained for each ROI. If desired, the color system variable values from each ROI may be combined mathematically to find average, differential or blended values for larger areas, block 142. For example, in some embodiments, a color system variable value is calculated for all horizontal ROIs as a group, producing an average top color value, average middle color value and average bottom color value. Examining the subtractive difference between these helps assess whether the blanket is curing evenly top to bottom. Similarly, all vertical ROIs of a single lane may be averaged to assess the evenness of cure from right lanes to left lanes. Finally, in some embodiments, it may be useful to combine all ROIs together to assess an average cure of the entire end face. It is to be understood that any process performing such arithmetic manipulations of two or more signals or values is necessarily encompassed by the step of sensing “at least one” variable, since at least two must be sensed for comparisons.

A key feature of the invention is the ability to see inside the pack to a “sectioned” or interior face on a continuous basis to examine cure state within the pack. This is very different from existing online systems that look only at the exterior surface, and from existing offline visual or color systems that cannot be performed on a continuous basis.

Many software packages will also provide statistical measures of the variability of the data collected, such as minimum, maximum, range, mean, median, standard deviation, etc. It is assumed for discussion that only one color system variable is measured. While that may be sufficient, in some embodiments it may be desirable to measure from each ROI multiple color system variables (such as but not limited to L, A and B, see below) and statistical information for each value. All the color value data is examined by a processor, which can report the existence and location of areas that may be undercured (or overcured), block 144. Subsequently, the process controls may be adjusted to improve the cure status, block 146.

### Corrective Actions and MPC Processor/Optimizer Control

Corrective actions to adjust process controls are made in reaction to a particular cure status situation or circumstance. For example, right-to-left or side-to side variations (cross machine or Y direction) in cure might warrant adjustment of the pneumatic lappers to achieve a more uniform lateral weight distribution. The bottom layer is sometimes more cured due to a variety of possible reasons, including, e.g. upward convection of high temperature air in zones 1 and 2 of the oven and conduction of additional heat from the conveyor chain 64 as the pack traverses the oven. Undercured top areas (relative to middle or bottom) may suggest higher temperatures or higher fan speeds in zones 3 and 4 (which have downdraft airflow) or, conversely, by reducing the temperature or airflow in zones 1 and 2. Undercure in the middle ROI (relative to top and bottom) might suggest reducing moisture at middle forming units. Additional possible corrective actions that might be taken in response to various cure status conditions are identified in Example 7, below.

Such corrective actions may be made manually, but an automated system for maintaining the operations of the forming hood and oven within specified control limits is more desirable. Proportional-Integral-Derivative (PID) controllers may offer suitable control solutions for simpler operations processes. These are well known in the art and need no further description. They are frequently used for single-loop feedback control systems.

Model Predictive Control (MPC) systems are also well known tools for more complex and dynamic plant operations process management. See, for example, Zheng (Ed.) Model Predictive Control, Sciyo, 2010 (downloadable at: http://www.intechopen.com/books/show/title/model-predictive-control) or Badgwell & Qin, Industrial Model Predictive Control—An Updated Overview, presentation Mar. 9, 2002 (cited at: http://www.nt.ntnu.no/users/skoge/presentation/mpc_badgwell/mpc_survey_handout.pdf as of Oct. 11, 2011), both incorporated by reference in their entireties. MPC originated in the chemical industry and provides an iterative means to monitor multiple dependent and independent variables sampled periodically from the operating process, and to predict the effect on dependent variables of adjusting the independent variables. This is generally done over a limited time horizon in a dynamic fashion so as to optimize an economic or cost variable. Software systems for implementing MPC are available from a wide variety of suppliers, including AspenTech, Honeywell, Shell Global Systems, Invensys, Continental Controls, and Pavillion/Rockwell. Various MPC algorithms are employed by different providers, the details of which are not essential. In general, the algorithms use either linear or non-linear programming; and empirical data or “first principles” theories (such as conservation and balance of energy and/or mass) to make predictions as to the adjustments. In some embodiments of the invention, the MPC optimizer algorithm involves two steps. In a first step, it solves a steady-state optimization problem using linear programming (LP) to identify an optimum operating point. Then, in a second step using dynamic optimization, the optimal steady-state operating condition from the first step is imposed on the control problem.

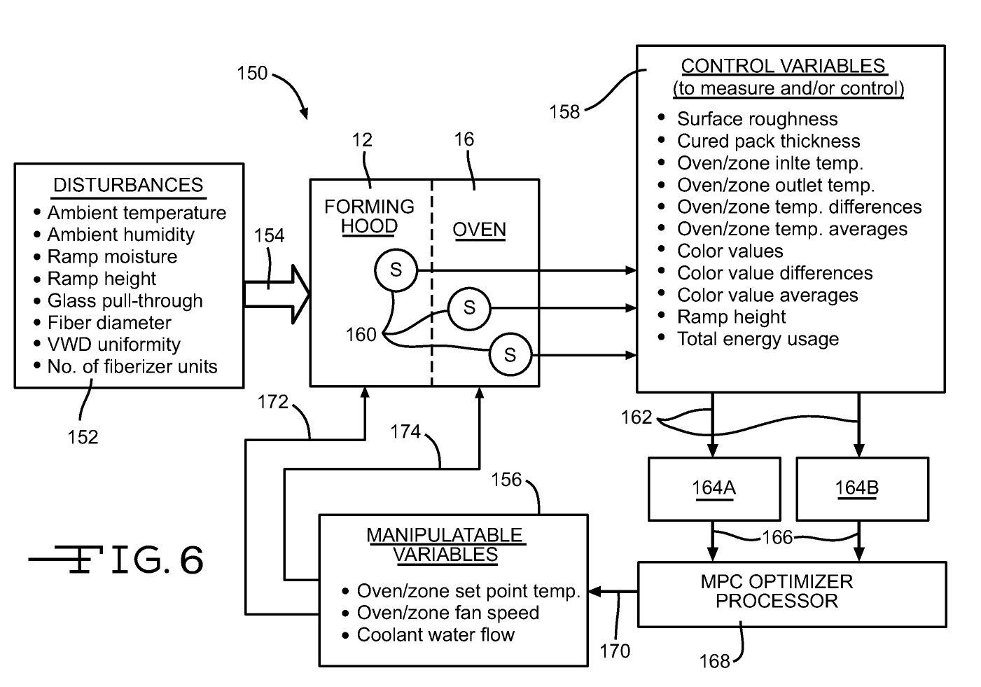

FIG. 6 shows a schematic diagram of a general fibrous product operation 150, including a forming hood or section 12 and an oven 16. Disturbances 152 are shown impacting the operation 150 at arrow 154, and they may impact the forming hood 12 or the oven 16 or both. As used herein, “disturbances” 152 refer to the input variables that are not easily controlled in the process. They may be measured or unmeasured, dependent or independent. For example, in a typical manufacturing plant for fibrous products, the ambient temperature and humidity are independent and not easily controlled. Similarly, for a given product specification, the fiber diameter and glass pull-through (glass flow rate to fiberizers) are not easily controlled. Occasionally, one or more fiberizer units may have to be taken off-line for cleaning, adjustment, or repair, so the numbers of fiberizer units in operation (relative to planned number for the given product run) is not controllable. Finally, certain properties of the pack on the ramp between forming hood and oven are dependent, but not directly controllable. These include the pack's moisture content and its thickness or “ramp height” (which are dependent on the water inputs and humidity) and its weight distribution vertically (which is dependent on binder application and glass pull-through at each fiberizer unit). All the above variables, and those similarly not easily controlled, are disturbances 152. Although the pack moisture and thickness may be considered disturbances from the standpoint of oven controls, they may also be considered control variables in the larger context of the overall forming operation, where flows of liquids are controllable and have an indirect impact on ramp height and moisture. Pack moisture affects drying distance, which can be determined by the delta T measure described above in connection with Table B. Within the constraints of oven fan speed limits, the oven optimizer control can control delta T to reject unmeasured disturbances of pack moisture.

The independent variables that can be adjusted easily are the “manipulatable” variables 156 as used herein. These are the so-called “knobs” and “levers” that can be adjusted to impact the operation 150. In the case of a fibrous product forming operation, the manipulatable variables 156 include the oven or zone fan speeds, the oven or zone set point temperatures, the coolant water flow rate and, optionally, the binder diluent flow rate (which adds additional water without impacting binder delivery). Binder flow rates, while controllable, are dictated by the desired loading rate (LOI) and product properties and are not considered “manipulatable” variables 156 for this reason.

Variables that are dependent on the input variables and can be measured in an on-line or “continuous” fashion are potential “control variables” 158. These are the process variables whose values the operator and the MPC seek to maintain within specified acceptable limits. Important “Control Variables” 158 are further described in Table D, below.

TABLE D
Potential Control Variables

| Short Name | Description |
|---|---|
| Surface | The finish, uniformity and smoothness of the exterior |
| Roughness | surface of the pack. |
| Cured pack | Also known as “machine height” this is the thickness |
| thickness | of the blanket after it exits the oven. |
| Oven/zone | The temperature sensed by the inlet thermocouples that |
| inlet temp. | are upstream of the drying/curing media in the oven or |
| | in a particular zone of the oven. These will generally |
| | be close to the oven zone temperature setpoint, once |
| | steady state is achieved after an adjustment is made. |
| Oven/zone | The temperature sensed by the outlet thermocouples that |
| outlet temp. | are downstream of the drying/curing media in the oven or |
| | in a particular zone of the oven. Depending on the location |
| | in the oven, these may not be very close to the oven zone |
| | temperature setpoint, due to energy absorption by the |
| | moisture in the drying pack. |
| Oven/zone | The difference between the temperatures sensed by any two |
| temp. | thermocouples located anywhere in any zone, as explained |
| differences | in more detail above in the section “Temperature variables.” |
| Oven/zone | The average temperatures sensed by any two or more |
| temp. | thermocouples located anywhere in any zone, as explained |
| averages | in more detail above in the section “Temperature variables.” |
| Color | A color value measured from any section as a variable of a |
| values | color system, such as the LAB or other systems described |
| | above in the section “Color value variables and detection |
| | system”. |
| Color value | The difference between two measured color values as |
| differences | described above in the section “Color value variables |
| | and detection system”. |
| Color value | The average of two or more measured color values as |
| averages | described above in the section “Color value variables |
| | and detection system”. |
| Ramp | The thickness of the pack as it enters the oven. This can |
| height | be viewed as a disturbance from the viewpoint of oven |
| | controls, but it does respond to levels of coolant water |
| | flow, so it can be thought of as controlled indirectly when |
| | coolant flow is manipulatable. |
| Total Energy | The total energy used by the system in BTU or equivalent |
| Usage | units, generally expressed per unit time or per quantity |
| | or units of production. |

Sensors 160 sense and measure one or more of the control variables 158. Suitable exemplary sensors 160 are described above as the thermocouples 95-98 and image capture system 200. Sensors 160 produce signals 162 that may be processed through comparators or other processors 164a, 164B, such as the thermal processor 110 or the image processor 134 already described. Processors 164A, 164B then output signals 166 that are input to the MPC system 168. After processing according to its algorithm and variable prioritization (described below) the MPC processor outputs one or more control signals 170 to the one or more of the manipulatable variables 156, which lead to controls of the operation via signals 172 and 174. As shown in FIG. 6, signals 172 control forming hood manipulatable variables 156, while signals 174 control oven manipulatable variables 156. For simplicity, only one control signal line is shown (at 170, 172, and 174), but it should be understood that multiple signal lines may be required depending on the number of variables measured or controlled. Two sensor signals 162, and two comparator processor output signals 166 are shown representing the minimum for a multivariable process control, although more than two signals are used in many embodiments.

Any one or more of these control variables 158 may be selected for process control to be maintained within predetermined limits. For example, 2 or more, 3 or more, 4 or more, 6 or more, 8 or more, or 10 or more variables may be selected for controlling. Typically at least one is selected for optimization once all identified control variables are within their limits. Typically, the optimization variable is one representing cost or other economic benefit. In the present invention, the total energy used is a useful proxy for cost and the MPC processor will choose conditions that minimize total energy (maximize economic benefit) once all variables are in control.

If two or more potential control variables are selected to be controlled by the MPC, they may be ranked in terms of priority for maintaining within their respective limits. This may be necessary as the limits for multiple control variables could impose so many constraints on the operation that there may be no feasible solution that satisfies all constraints. Therefore, prioritization of the control variables may be useful to tell the MPC optimizer which control limits may be sacrificed in favor of maintaining other control variables within their limits. Control variables may be ranked in strict ordinal fashion, or grouped into two or more tiers ranging from most important, through lesser importance to least important. While many prioritization schemes may be useful for manufacturing fibrous products like insulation, applicants have found the prioritization of table E useful. Other options are illustrated in the examples.

TABLE E
Illustrative Control Variable Prioritization

| | |
|---|---|
| Highest priority | Color values, such as color B values and average |
| | color B values |
| | Ramp height |
| Intermediate | Color value differences, such as the B value difference |
| Priority | between top and bottom ROIs of a section, or between |
| | edge and interior lane ROIs of a section |
| | Zone temperature differences, such as the difference |
| | between downstream entry of zone 1 and downstream |
| | egress of zone 2 (delta T) in a four zone oven |
| | Zone outlet temperatures, especially at curing zones, |
| | such as zones 3 and 4 in a four zone oven |
| | Ramp height |
| Lowest Priority | Oven gas/energy usage |

The invention has been described above in terms of many of its embodiments and options. The following examples serve to further illustrate specific embodiments of the invention, but the scope of the invention should not be construed as limited to these examples.

### EXAMPLES

### Examples 1-3

### Exemplary MPC Optimization

A MPC optimizer from AspenTech is programmed to monitor and control the variables shown in Table 1, below, in a four zone oven using the manipulated variables of: (1) fan speeds in zones 1-4, and (2) setpoint temperatures in zones 1-4. In each case, total energy use is selected for optimization, once selected variables are in control.

TABLE 1
Selected Optimization Schemes

| Example | | | |
|---|---|---|---|
| No. | Controlled variables | | Prioritization to: |
| 1 | 1. | Color B value | Color B value |
| | 2. | Average of multiple pack outlet | |
| | | temperatures at entry location of each | |
| | | of zones 1-4 | |
| | 3. | Average of multiple pack outlet | |
| | | temperatures at egress location of | |
| | | each of zones 1-4 | |
| 2 | 1. | Color B value | Color B value |
| | 2. | Average of multiple pack outlet | |
| | | temperatures at egress location of | |
| | | each of zones 1-4 | |
| 3 | 1. | Color B value | Color B value |
| | 2. | Average of pack outlet temperature at | |
| | | egress location of zones 1, 3 and 4 | |
| | 3. | Difference between inlet and outlet | |
| | | temperatures at egress location of | |
| | | zone 2 (i.e. Z2GI − Z2GO) | |
| 4 | 1. | Color B value | Color B value |
| | 2. | Average of pack outlet temperature at | |
| | | egress location of zones 1, 3 and 4 | |
| | 3. | Difference between temperatures at | |
| | | zone 1 entry outlet and zone 2 egress | |
| | | outlet (i.e. Z2GO − Z1NO) | |

### Examples 5-6

### Exemplary MPC Optimization

A MPC optimizer from AspenTech is programmed to monitor and control the variables shown in Table 2, below, in a four zone oven using the manipulated variables of: (1) fan speeds in zones 1-4, (2) setpoint temperatures in zones 1-4; and (3) coolant water flow into the forming hood. In each case, total energy use is selected for optimization, once selected variables are in control except, in Example 5, Color B difference was selected as a secondary optimization variable in addition to total energy use.

TABLE 2
Selected Optimization Schemes

| Example | | | |
|---|---|---|---|
| No. | Controlled variables | | Prioritization to: |
| 5 | 1. | Ramp height | Color B difference |
| | 2. | Difference between inlet and outlet | |
| | | temperatures at egress location of | |
| | | zone 2 (i.e. Z2GI − Z2GO) | |
| | 3. | Average of multiple pack outlet | |
| | | temperatures at egress location of | |
| | | each of zones 2-4 | |
| | 4. | Overall color B value | |
| | 5. | Difference in color B values | |
| | | between top and bottom ROIs of a | |
| | | section | |
| 6 | 1. | Color B value | order listed |
| | 2. | Ramp height | |
| | 3. | Difference in color B values | |
| | | between top and bottom ROIs of a | |
| | | section | |
| | 4. | Difference between inlet and outlet | |
| | | temperatures at egress location of | |
| | | zone 2 (i.e. Z2GI − Z2GO) | |
| | 5. | Average of multiple pack outlet | |
| | | temperatures at egress location of | |
| | | each of zones 2-4 | |

### Example 7

### Selected Corrective Actions

The following Action Tables set forth some corrective actions to take in given situations depending on the cure status of various sampled locations. Many of these can be automated using continuous, online measurements and a dynamic MPC processor.

### Process Issue: Bright Pink Areas in Interior Batts (Under Cure)

Action

Ensure proper weight distribution across all lanes
Look for plugged areas on the Oven Flights
Look for sources of excess moisture on the Forming Chain
Look for sources of excess moisture from the fiberizing area
Ensure that Oven fan speeds are optimized: run each fan as fast as
possible without blowing craters in the surface (updraft zones) or
degrading machine thickness (downdraft zones).

### Process Issue: Interior Top Is Under Cured

Action

Check for plugged areas on top oven chain
Verify Ramp Height is at target
Increase temperature in last two oven zones by 5° each (react zone) or
10° each (reject zone)
Increase fan speeds in last two oven zones by 50 rpm each - ensure that
pack is still touching top oven chain at discharge end and surface quality
is not affected

### Process Issue: Interior Bottom Is Under Cured

Action

Look for sources of excess moisture from the fiberizing area; especially
on initial units that from the “bottom” of pack.
Look for sources of excess moisture on forming chain- i.e. under chain
sprays, leaking hoses, etc.
Look for overflowing catch pans or hoodwall troughs
Ensure proper operation of forming chain cleaner sprayer
Ensure proper operation of forming flight dryer
Check for plugged areas on bottom oven chain
Verify Ramp Height is at target
Increase temperature in first two oven zones by 5° each (react zone) or
10° each (reject zone)
Increase fan speeds in first two oven zones by 50 rpm each - ensure that
surface quality is not degraded (blowing holes in pack) and pack is still
touching top oven chain at discharge

### Process Issue: Edge Is Under Cured

Action

Ensure hoodwalls are rotating and squeegees are drying the belt
If edge sprays are being used, reduce flow or turn off
Check for plugged area on top and bottom oven chains, especially the
edges
Ensure that pack is centered on the oven chain. If not, air will bypass
the pack through the open chain, reducing cure on that edge of the
pack.
Verify Ramp Height is at target
Verify deckles are in correct position (if applicable)
Increase temperature in first two oven zones by 5° each (react zone) or
10° each (reject zone) Note that this will also increase cure throughout
the pack, so ensure that this move will not create an over-cured
condition elsewhere!

### Process Issue: Interior Top Is Over Cured

Action

Verify Ramp Height is at target
Decrease temperature in last two oven zones by 5° each (react zone) or
10° each (reject zone)

### Process Issue: Interior Bottom Is Over Cured

Action

Verify Ramp Height is at target
Decrease temperature in first two oven zones by 5° each (react zone) or
10° each (reject zone)

### Process Issue: Edge Is Over Cured

Action

Ensure that pack is centered on the oven chain
Verify Ramp Height is at target
Verify deckles are in correct position (if applicable)
Decrease temperature in first two oven zones by 5° each. Note that this
will also decrease cure results for the other areas of the pack, so ensure
that this move will not create an under-cured condition elsewhere!
Ensure proper edge trim width

### Product Issue: All Regions Under Cured

Action

Verify Ramp Height is at target
Increase all Oven Zone temps by 5° each (react zone) 10° each (react
zone)
If oven changes do not result in increased cure, verify ramp moisture
is in acceptable range for the line. Extreme ambient conditions may
result in the inability to properly cure product, at which time it is
recommended to change jobs.

### Product Issue: All Regions Over Cured

Action

Verify Ramp Height is at target
Increase all Oven Zone temps by 5° each (react zone) 10° each (react
zone)

The foregoing description of the various aspects and embodiments of the present invention has been presented for purposes of illustration and description. It is not intended to be exhaustive, or to identify all embodiments, or to limit the invention to the specific aspects disclosed. Obvious modifications or variations are possible in light of the above teachings and such modifications and variations may well fall within the scope of the invention as determined by the appended claims when interpreted in accordance with the breadth to which they are fairly, legally and equitably entitled.

What is claimed is:

1. Apparatus for controlling the cure status of binder applied to a fibrous product manufactured in a manufacturing line, the apparatus comprising:
a curing oven having at least two zones with blowers for circulating heated gas through the oven zones, manipulatable controls for varying at least one operating parameter of the manufacturing line;
a first sensor for generating a first signal indicative of the cure status of the fibrous product, and a distinct second sensor for generating a distinct second signal indicative of the cure status of the fibrous product;
a processor for receiving the first and second signals from the first and second sensors and generating at least one control signal for adjusting at least one of the manipulatable controls of the manufacturing line in response to the first and second signals indicative of the cure status.

2. The apparatus of claim 1 wherein the manipulatable controls are selected from oven zone fan speeds, oven zone setpoint temperatures and coolant water flow.

3. The apparatus of claim 1 wherein the first and second sensors are independently selected from a thermocouple and an image capture system.

4. The apparatus of claim 3 wherein at least one sensor comprises at least one thermocouple sensor located at an egress location of at least one oven zone.

5. The apparatus of claim 3 further comprising a plurality of sensors, each generating a respective signal indicative of the cure status of the fibrous product.

6. The apparatus of claim 1 wherein at least two sensors are thermocouples and the two thermocouples are located at locations selected from:
an entry and an egress location in the same oven zone;
an entry and an egress location in different oven zones;
an inlet and an outlet location in the same oven zone; and
an inlet and an outlet location in the same oven zone.

7. The apparatus of claim 6 further comprising a comparator for subtracting the first and second signals to form a temperature difference.

8. The apparatus of claim 7 wherein the temperature difference represents an egress to entry temperature difference.

9. The apparatus of claim 6 further comprising a comparator for averaging the first and second signals to form an average temperature.

10. The apparatus of claim 1 wherein at least one sensor comprises an image capture system generating a signal representing a color value of the fibrous pack.

11. The apparatus of claim 10 wherein at least one sensor is an image capture system generating multiple signals representing color values from multiple ROIs of the fibrous pack, and further comprising a processor for subtracting one color value from another to form a color differential signal.

12. The apparatus of claim 11 wherein the color differential value represents the difference between a top layer color value and a bottom layer color value.

13. The apparatus of claim 1 further comprising a ramp height sensor at a location prior to entering a first oven zone.

14. The apparatus of claim 13 further comprising a plurality of sensors, each generating a respective signal indicative of the cure status of the fibrous product, and wherein:
at least one sensor comprises a thermocouple;
at least one sensor comprises an image capture system; and
at least one sensor comprises a ramp height sensor.

15. A method for controlling the cure status of binder in a fibrous product manufactured on a manufacturing line including a curing oven and manipulatable controls for the operating parameters of the manufacturing line, the method comprising:
sensing at least one first control variable indicative of the cure status of the fibrous product, and generating a first signal indicative of the cure status;
sensing at least one distinct second control variable indicative of the cure status of the fibrous product, and generating a distinct second signal indicative of the cure status;
inputting the first and second signals to a MPC processor-optimizer capable of solving for optimal control conditions, given predetermined constraints for the control variables and an optimizing function; and
generating at least one output control signal from the MPC processor-optimizer to adjust at least one of the manipulatable controls of the manufacturing line in response to the optimal condition.

16. The method of claim 15 wherein the manipulatable controls are selected from oven zone fan speeds, oven zone set point temperatures and coolant water flow.

17. The method of claim 15 wherein the first and second sensing steps are done with sensors independently selected from a thermocouple for sensing a temperature and an image capture system for sensing an image.

18. The method of claim 15 wherein at least one of the first and second sensing steps is done with a thermocouple, and further comprising sensing at least an outlet temperature.

19. The method of claim 18 further comprising at least two sensing steps using thermocouple sensors and further comprising subtracting the first and second signals to form a temperature difference.

20. The method of claim 19 wherein the subtracting to form a temperature difference further comprises at least one of:
subtracting an outlet temperature from an inlet temperature in the same oven zone;
subtracting an outlet temperature from an inlet temperature in different oven zones;
subtracting an egress temperature from an entry temperature in the same oven zone; and
subtracting an egress temperature from an entry temperature in different oven zones.

21. The method of claim 18 further comprising at least two sensing steps using thermocouple sensors and further comprising averaging the first and second signals to form an average temperature.

22. The method of claim 15 wherein at least one of the first and second sensing steps is done with an image capture system for generating a signal representing a color value of the fibrous pack.

23. The method of claim 22 wherein the color value is selected from L, L*, A, a*, B and b*.

24. The method of claim 22 wherein the sensing step further comprises generating multiple signals representing color values from multiple ROIs of the fibrous pack, and subtracting one color value from another to form a color differential value.

25. The method of claim 24 wherein the color differential value represents the difference between a top layer color value and a bottom layer color value.

26. The method of claim 15 wherein at least one of the sensing steps further comprises sensing the outlet temperature of an oven zone, and at least one other sensing step further comprises sensing a color value of fibrous product exiting the oven.
